(19) United States
(12) Patent Application Publication
(10) Pub. No.: US 2003/0058473 A1
(43) Pub. Date: Mar. 27, 2003

(54) Label producing method and apparatus

(76) Inventors: Takeshi Hosokawa, Shiojiri-shi (JP); Tomoki Nakamura, Tokyo (JP)

Correspondence Address: HOGAN & HARTSON L.L.P., 500 S. GRAND AVENUE, SUITE 1900, LOS ANGELES, CA, 90071-2611, US

(21) Appl. No.: 10/236,007

(22) Filed: Sep. 5, 2002

(30) Foreign Application Priority Data
Sep. 10, 2001 (JP) 2001-273502

(51) Int. Cl. G06K 1/00; G06F 15/00

(52) U.S. Cl. 358/1.18

(57) ABSTRACT

There are provided a label producing method and apparatus which is capable of easily producing an index tab label which has front and rear faces thereof printed with indexes partially different from each other. According to the label producing method and apparatus, when an index tab label is produced which has character strings printed on opposite sides of an imaginary center line thereof, and is capable of forming an index tab by being folded along the imaginary center line and affixed such that the index tab has the character strings printed on a front face and a rear face thereof as a front index and a rear index for affixation to an object article, a front side character string is entered and edited for forming the front index printed on the front face of the index tab. The front side character string is copied to form a draft of a rear side character string for forming the rear index printed on the rear face of the index tab. Then, the rear side character string formed as the draft of the rear side character string is edited, and the front side character string and the edited rear side character string are printed side by side on a print medium such that the index tab label can be produced.

### BACKGROUND OF THE INVENTION

1. Field of the Invention

This invention relates to a label producing method and apparatus for producing an index tab label having front and rear faces thereof printed with indexes.

2. Prior Art

To produce an index tab label that is folded along an imaginary center line thereof and then affixed to a document file or the like for use as an index tab, a label producing apparatus also called “label writer”, for instance, is employed to print character strings on opposite sides of a predetermined imaginary center line of a print medium (tape) for a label such that they form indexes on the front and rear faces of the index tab, and the printed portion of the print medium is cut off to a size of the index tab, thereby producing the index tab label. In this case, basically, the user is required to enter (character strings for) respective indexes for the front and rear faces of the index tab. For index tab labels having the same index printed on the front and rear faces thereof, a label producing apparatus (tape printing apparatus) has been proposed e.g. in Japanese Laid-Open Patent Publication (Kokai) No. 10-818, which is capable of producing an index tab label G100 (see FIG. 13B) by executing entry of an index (character string “SALES” shown in the figure) only for the front face of an index tab, as shown in FIG. 13A, thereby saving the trouble of entering the same index for the rear face of the index tab.

However, the above conventional label producing method and apparatus therefor are ready only for a case where indexes to be printed on the front and rear faces of an index tab are identical to each other in contents, and hence they cannot cope with a case where indexes are partially different from each other. In such a case, it is required after all to enter indexes separately as respective two lines of a document for the opposite faces, and then work them out as desired indexes by editing, which makes the editing operations very troublesome.

### SUMMARY OF THE INVENTION

It is an object of the invention to provide a label producing method and apparatus which is capable of easily producing an index tab label which has front and rear faces thereof printed with indexes partially different from each other.

To attain the above object, according to a first aspect of the invention, there is provided a label producing method for producing an index tab label which has character strings printed on opposite sides of an imaginary center line thereof, and is capable of forming an index tab by being folded along the imaginary center line and affixed such that the index tab has the character strings printed on a front face and a rear face thereof as a front index and a rear index,

the label producing method comprising the steps of:

entering and editing a front side character string for forming the front index printed on the front face of the index tab;

producing a draft of a rear side character string for forming the rear index printed on the rear face of the index tab by copying the front side character string;

editing the rear side character string formed as the draft of the rear side character string; and

printing the front side character string and the edited rear side character string side by side on a print medium such that the index tab label can be produced.

To attain the above object, according to a second aspect of the invention, there is provided a label producing apparatus for producing an index tab label which has character strings printed on opposite sides of an imaginary center line thereof, and is capable of forming an index tab by being folded along the imaginary center line and affixed such that the index tab has the character strings printed on a front face and a rear face thereof as a front index and a rear index,

the label producing apparatus comprising:

front side character string entry means for entering and editing a front side character string for forming the front index printed on the front face of the index tab;

rear side character string draft-producing means for producing a draft of a rear side character string for forming the rear index printed on the rear face of the index tab by copying the front side character string;

rear side character string-editing means for editing the rear side character string formed as the draft of the rear side character string; and

printing means for printing the front side character string and the edited rear side character string side by side on a print medium such that the index tab label can be produced.

According to this label producing method and apparatus, an index tab label is produced which has character strings printed on opposite sides of an imaginary center line thereof, and is capable of forming an index tab by being folded along the imaginary center line and affixed such that the index tab has the character strings printed on a front face and a rear face thereof as a front index and a rear index. In this process, first, a front side character string is entered and edited, and copied to form a draft of a rear side character string. Then, the front side character string and the edited rear side character string are printed side by side on a print medium, whereby an index tab label can be produced. In this case, the front side character string is copied to form a draft of the rear side character string, so that when only part of an index on the back side is different from an index on the front side, there is no need to enter the whole rear side character string, and only the different part is required to be edited. This makes it possible to save the trouble of entering the rear side character string. Moreover, since the front and rear faces of a label do not have to have the same index, an index tab label can be easily produced which has front and rear faces thereof printed with indexes partially different from each other.

Preferably, the front side character string and the rear side character string are handled as respective lines of a document formed by two lines of character strings in total, and entry of the front side character string is finally determined in response to a new line start instruction after all the characters forming the front side character string have been entered.

According to this preferred embodiment of each of the label producing method and apparatus, the front side character string and the rear side character string are handled as respective lines of a document formed by two lines of character strings in total, and entry of the front side character string is finally determined in response to a new line start instruction after all the characters forming the front side character string have been entered. As a result, similarly to a case where transition from entry and edit of a first line to edit of a second line is carried out during editing of a general document comprised of two lines, transition from entry and edit of the front side character string to edit of the rear side character string can be performed easily in response to the new line start instruction, which contributes to facilitating editing operations.

Preferably, the label producing method further includes the step of displaying a line printed with the front side character string and a line printed with the rear side character string as the respective lines of the document.

Preferably, the label producing apparatus further includes display means for displaying a line printed with the front side character string and a line printed with the rear side character string as the respective lines of the document.

According to these preferred embodiments, since the line of the front side character string and the line of the rear side character string are displayed as the respective lines of the document, it is possible to easily enter and edit the character strings with reference to the results of the display.

Preferably, the step of producing a draft of the rear side character string includes starting a process for producing the draft by using the new line start instruction as a trigger.

Preferably, the rear side character string draft-producing means starts a process for producing the draft by using the new line start instruction as a trigger.

According to these preferred embodiments, since the process for producing the draft is triggered by the new line start instruction, it is possible to clearly restrict (control) timing in which transition from the entry and edit of the front side character string to the edit of the rear side character string is carried out. This facilitates the operating procedures and editing operations.

Preferably, the step of producing a draft of the rear side character string includes the step of automatically copying the front side character string to produce the draft.

Preferably, the rear side character string draft-producing means includes automatic copying means for automatically copying the front side character string to produce the draft.

According to these preferred embodiments, since the front side character string is automatically copied to produce the draft, it is possible to save the trouble of instructing the copying of the front side character string again.

Preferably, the front side character string automatically copied is dealt with as a provisionally determined draft of the rear side character string, and the step of editing the rear side character string includes the step of finally determining the provisionally determined draft of the rear side character string document.

Preferably, the front side character string automatically copied is dealt with as a provisionally determined draft of the rear side character string, and the rear side character string-editing means includes rear side character string draft-determining means for finally determining the provisionally determined draft of the rear side character string.

According to these preferred embodiments, the front side character string automatically copied is dealt with as a provisionally determined draft of the rear side character string, and determined during editing. In other words, copied text of the front side character string is once placed in a provisionally determined state in the course of copying, so that when the rear side character string is edited, it is possible to carry out processing only enabled for the draft in the provisionally determined state.

Preferably, the step of editing the rear side character string includes the step of being capable of deleting the draft of the rear side character string in response to an instruction for deleting the provisionally determined draft.

Preferably, the rear side character string-editing means includes provisionally determined rear side character string-deleting means capable of deleting the draft of the rear side character string in response to an instruction for deleting the provisionally determined draft.

According to these preferred embodiments, the draft of the rear side character string can be deleted in response to the instruction for deleting the provisionally determined draft. This facilitates employment of a method other than the method of simply copying the front side character string, thereby enhancing the freedom of editing.

Preferably, the instruction for deleting the provisionally determined draft is issued by the same operation as carried out in issuing an instruction for deleting one character from the determined draft of the rear side character string.

According to this preferred embodiment of each of the label producing method and apparatus, the instruction for deleting the provisionally determined draft is issued by the same operation as carried out in issuing an instruction for deleting one character from the determined draft of the rear side character string. More specifically, the same operation produces different results depending on whether or not the rear side character string is provisionally determined. Inversely, it is possible to instruct different processes responsive to circumstances by the same operation, thereby increasing the range of operability of the apparatus in editing.

Preferably, the step of producing a draft of the rear side character string includes the steps of confirming whether copying of the front side character string should be executed or inhibited, and executing the copying of the front side character string when it is confirmed that copying of the front side character string should be executed.

Preferably, the rear side character string draft-producing means includes copy execution-confirming means for confirming whether copying of the front side character string should be executed or inhibited, and copy execution means for executing the copying of the front side character string when it is confirmed that the copying of the front side character string should be executed.

According to these preferred embodiments, it is confirmed whether the copying of the front side character string should be executed or inhibited, and the copying is executed when it is confirmed that the copying is to be executed. More specifically, since the copying of the front side character string goes through the step of questioning whether the copying is to be executed or inhibited, it is possible not only to copy the front side character string unconditionally but also to carry out a process only enabled before execution of the copying operation and/or select inhibition of the copying operation, with increased freedom. This makes it possible to edit character strings more easily.

Preferably, the step of producing a draft of the rear side character string further includes the step of being capable of stopping execution of the copying of the front side character string in response to denial of the execution of the copying.

Preferably, the rear side character string draft-producing means further includes copy execution-stopping means capable of stopping execution of the copying of the front side character string in response to denial the execution of the copying.

According to these preferred embodiments, the execution of the copying of the front side character string can be stopped in response to denial of the execution of the copying. This facilitates employment of a method other than the method of simply copying the front side character string, thereby enhancing the freedom of editing.

Preferably, the step of producing a draft of the rear side character string includes the steps of being capable of instructing execution of the copying of the front side character string, and carrying out the copying of the front side character string when the execution of the copying is instructed.

Preferably, the rear side character string draft-producing means includes copy execution-instructing means capable of instructing execution of the copying of the front side character string, and copy execution means for executing the copying of the front side character string when the execution of the copying is instructed.

According to these preferred embodiments, the execution of the copying of the front side character string can be instructed, and when the execution of the copying is instructed, the copying of the front side character string is executed. More specifically, it is possible to instruct whether copying is to be permitted (or executed) or not. Since the copying is carried out only going through the instruction step, it is possible not only to copy the front side character string unconditionally but also to carry out processing enabled only before copying or select inhibition of the copying, with increased freedom. This further facilitates editing.

Preferably, the step of producing a draft of the rear side character string includes the step of setting a blank to the draft of the rear side character string in place of executing the copying of the rear side character string.

Preferably, the rear side character string draft-producing means includes blank draft-producing means for employing a blank as the draft of the rear side character string in place of executing the copying of the rear side character string.

According to these preferred embodiments, by forming the draft of the rear side character string as a blank without executing the copying of the rear side character string, the rear side character string can be formed (edited) by editing the blank as the draft (i.e. by carrying out a new entry). This facilitates employment of a method other than the method of simply copying the front side character string, thereby making it possible to enhance the freedom of editing.

The above and other objects, features, and advantages of the invention will become more apparent from the following detailed description taken in conjunction with the accompanying drawings.

### BRIEF DESCRIPTION OF THE DRAWINGS

FIG. 1 is a block diagram schematically showing a control system of a tape printing apparatus to which is applied a label producing method and apparatus according to an embodiment of the invention;

FIG. 2 is a flowchart showing a conceptual representation of an overall control process executed by the FIG. 1 tape printing apparatus;

FIG. 3 is a diagram showing an example of a sequence of screens displayed during a printing process, which is useful in explaining a typical operating procedure for execution of the process;

FIG. 4 is a diagram similar to FIG. 3, which illustrates an example of a sequence of screens displayed during a setting process for setting a special form;

FIG. 5 is a diagram similar to FIG. 3 and continued from FIG. 4;

FIG. 6 is a diagram showing examples of names of the special forms, examples of characters entered, and examples of portions of print images formed into labels, which are formed based on the special forms and the characters entered;

FIGS. 7A and 7B are diagrams showing examples of index tabs and index tab labels, which are useful in explaining examples of images of the index tab labels affixed to object articles;

FIG. 8 is a diagram similar to FIG. 3, which illustrates an example of a sequence of screens displaying states of character strings being edited in a special form of index/horizontal writing;

FIGS. 9A and 9B are diagrams similar to FIG. 8 and continued from FIG. 8;

FIG. 10 is a diagram similar to FIG. 8, which shows another example;

FIG. 11 is a diagram similar to FIG. 8, which shows still another example;

FIG. 12 is a diagram similar to FIG. 8, which shows still another example; and

FIGS. 13A and 13B are diagrams similar to FIG. 8, which show an example of an index tab label-producing process carried out by a conventional tape printing apparatus.

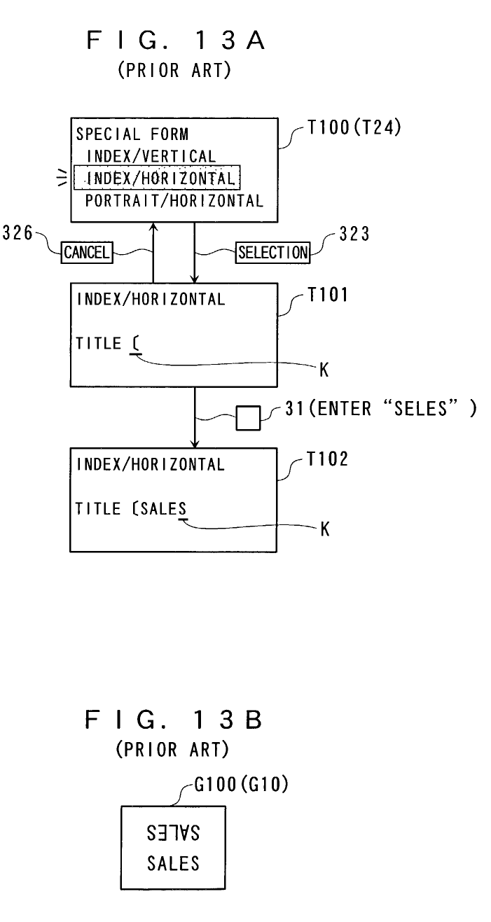

### DETAILED DESCRIPTION OF THE PREFERRED EMBODIMENT

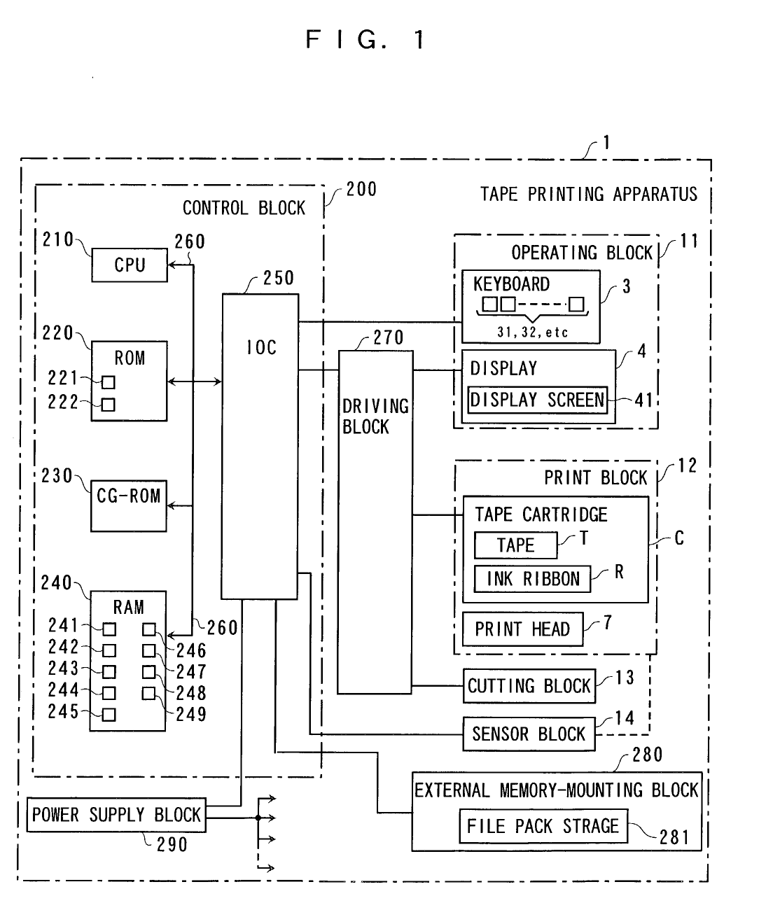

The invention will now be described in detail with reference to the drawings showing a tape printing apparatus to which is applied a label producing method and apparatus according to an embodiment of the invention. FIG. 1 shows a control system of the tape printing apparatus. The tape printing apparatus 1 carries out color printing of a print image on a tape T by a thermal printing method as well as cutting off the printed portion of the tape T to produce a label. The print image is formed based on desired letters and the like entered via a keyboard of the apparatus 1.

The tape T is comprised of a substrate tape, an adhesive layer coated on an underside surface of the substrate tape, and a release paper tape affixed to the adhesive layer. The substrate tape is formed of a material which is capable of sufficiently absorbing ink, such as paper, paper with a coated layer or a film with a coated layer. The adhesive layer is used for affixing a printed portion of the tape as a label to an object article, such as a file, while the release paper tape is used for preventing dust or dirt from depositing on the adhesive layer. Tape cartridges are provided which contain various kinds of tapes T having various tape widths of 4.5 mm to 48 mm or so. A print image having a resolution of 24 to 1024 dots or so in the direction of the width of the tape is printed on the tape T, dependent on the width thereof. It should be noted that there are provided still other tapes T different in material or having background colors other than white. Therefore, it is possible to use at least several tens of kinds of tapes T including ones to be adopted in the future.

As shown in FIG. 1, the tape printing apparatus 1 is basically comprised of an operating block 11 which includes the keyboard 3 and a display 4 and provides interface between the apparatus land the user, a printer block 12 which carries out printing on the tape T fed from the tape cartridge C by a print head 7 of a thermal type, a cutter block 13 for cutting off the printed portion of the tape T, a sensor block 14 having various sensors for carrying out various detecting operations, a driving block 270 having various drivers for driving circuits of blocks and devices, an external memory-mounting block 280 for removably mounting an external memory (called “file pack storage”) therein, a power supply block 290, and a control block 200 for controlling operations of components of the tape printing apparatus 1 including the above-mentioned sensors and drivers. To implement the above construction, the apparatus 1 contains a circuit board, not shown, in addition to the printer block 12, the cutter block 13, the sensor block 14, the external memory-mounting block 280, and so forth. On the circuit board are mounted the power supply block 290 and the circuits of the driving block 270 and the control block 200. A power supply unit of the power supply block 290 is connected to a connector socket connectable with an AC adapter, and a battery, such as a nicad battery, removably mounted from the outside of the apparatus, so as to supply power to the components of the tape printing apparatus 1.

Although detailed illustration and indication of each component are omitted, the printer block 12 has the tape cartridge c containing the tape T and an ink ribbon R within a cartridge casing. The tape cartridge C has a through hole for receiving therein a head unit arranged in a compartment of the printer block 12. The tape cartridge C contains a tape reel for receiving therein a positioning pin arranged in the compartment, and a ribbon take-up reel for receiving therein a ribbon take-up reel-driving shaft arranged in the compartment. Further, a platen roller for receiving therein a platen drive shaft arranged in the compartment is arranged within the tape cartridge at a location corresponding to the print head (thermal head) 7 incorporated in the head unit, where the tape T and the ink ribbon R overlap.

The tape cartridge 5 has a plurality of small holes formed in the bottom thereof for discrimination of the type of tape T contained therein from the other types of the tape T having different widths, which are contained in other tape cartridges 5. A tape-discriminating sensor, not shown, comprised e.g. of micro-switches is arranged in the compartment, for detecting these holes to thereby determine the type of tape T contained in the tape cartridge. Further, the compartment is provided with an ambient temperature sensor, such as a thermistor, which sends information of an ambient temperature detected thereby to the control block 200. Further, a head surface temperature sensor formed e.g. by a thermistor, is arranged on a surface of the print head 7 in a manner intimately contacting the surface, which sends information of the surface temperature of the thermal head 7 detected thereby to the control block 200. The apparatus casing is formed with a tape exit which communicates between the compartment and the outside of the apparatus. On the tape exit faces a tape cutter for cutting off a dispensed portion of the tape T.

When the tape cartridge C is mounted in the compartment, the through hole of the tape cartridge C receives therein the head unit, the tape reel receives therein the positioning pin, the platen roller receives therein the platen drive shaft, and the ribbon take-up reel receives therein the ribbon take-up reel drive shaft, which enables the feed of the tape T and the ink ribbon R. Further, in the above state, the print head 7 is brought into contact with the platen roller in a manner sandwiching the tape T and the ink ribbon R therebetween, whereby the apparatus is ready for a printing operation. When the tape T is rolled out from the tape reel, the ink ribbon R is also rolled out from the ribbon reel and fed or run together with the tape T in a state lying upon the tape T, followed by being taken up by the ribbon take-up reel. That is, the platen roller and the ribbon take-up reel are rotated in synchronism with each other, whereby the tape T and the ink ribbon R are simultaneously fed, and at the same time the print head 7 is driven in synchronism with running of the tape T and the ink ribbon R to thereby carry out printing.

In the tape printing apparatus 1, the user, after mounting the tape cartridge C in the compartment of the printer block 12, enters printing information of print images, such as desired characters (letters, numerals, symbols, figures and the like), via the keyboard 3, and at the same time confirms or views results of the entry on the display 4 for editing the same. Thereafter, when the user instructs a printing operation via the keyboard 3, the tape feeder of the printer block 12 is driven to unwind the tape T from the tape cartridge C, and at the same time the print head 7 is driven to print the desired characters on the tape T. The printed portion of the tape T is delivered from the tape exit, as the printing operation proceeds. After the desired characters have been printed in the above manner, the platen roller continues to rotate for a predetermined time period (the ribbon take-up reel also continues to rotate in synchronism with rotation of the platen roller), whereby the tape T continues to be fed until a predetermined cutting position on the tape T, which is adapted to a tape length including the length of a marginal area, reaches a point corresponding to a location of the tape cutter.

The tape feeder of the printer block 12 is arranged in a space extending from a lateral side of the compartment to a bottom side of the same, and rotates the platen drive shaft and the ribbon take-up reel drive shaft by using a tape feed motor (TF motor) arranged as a power (drive) source at a location laterally outward of the compartment. The tape feeder includes the TF motor, the platen drive shaft, the ribbon take-up reel drive shaft, a reduction gear train for transmitting part of the driving force of the TF motor to each of the drive shafts, and a chassis for supporting them thereon.

Further, the TF motor according to the present embodiment is implemented by a DC motor, and the tape feeder of the printer block 12 further includes an encoder for detecting the number of rotations of the TF motor (DC motor). The encoder is comprised of a disk, not shown, which is formed with four detection openings along a periphery thereof and rigidly fixed to an end of the main shaft of the DC motor, and a rotational speed sensor, not shown, which is comprised of a photo sensor which faces the detection openings of the disk, and a sensor circuit board supporting the photo sensor thereon to carry out photoelectric conversion in cooperation with the photosensor. The photosensor has a light-emitting element and a light-receiving element arranged in a manner opposed to each other. Light emitted from the light-emitting element passes through the detection openings (arranged along the periphery of the disk) of the encoder and is received by the light-receiving element whereby the number of rotations of the DC motor is detected (the number of pulses corresponding to the number of turns of the DC motor is generated). In other words, the on-off of the light received from the light-emitting element by the light-receiving element is photoelectrically converted by the sensor circuit board and output as a pulse signal to the control block 200. Of course, the above TF motor can also be constructed by a stepping motor (pulse motor) to omit the encoder such that the tape T can be fed with ease by a predetermined number of steps based on the pulse signal.

In FIG. 1, for convenience of description, it is assumed that the sensor block 14 includes the tape-discriminating sensor, the ambient temperature sensor, the head surface temperature sensor, and the rotational speed sensor, described hereinabove. The sensor block 14 delivers signals indicative of the sensed type of a tape, ambient temperature, head surface temperature, and rotational speed, generated by the respective sensors, to the control block 200. It should be noted that the sensor block 14 can be provided with other sensors, such as a voltage sensor which is connected to the power supply unit of the power supply block 290 that supplies power to the components of the tape printing apparatus 1, for detecting changes in the electric potential of the power supply unit, and the like, or some of the above sensors, such as the encoder can be omitted in the case of the TF motor being the pulse motor, to suit the actual requirements of the apparatus.

Next, the cutter block 13 includes a tape cutter and a cutter motor for actuating the tape cutter for cutting operations. When the tape T is cut automatically, e.g. in the case of fixed length printing, the tape T is further sent by the length of a rear margin after completion of the printing operation, and then stopped, whereupon the cutter motor is driven to cut off the tape T. It should be noted that the tape printing apparatus 1 is provided with a cut key for enabling the user to manually cut the tape by key stroke, and it is possible to switch between an automatic cutting mode and a manual cutting mode. In the manual cutting mode carried out e.g. in the case of a desired length printing, when the printing operation and additional feed of the tape are completed, the user depresses the cut key, whereby the tape cutter is actuated to cut off the tape T into a desired length.

The driving block 270 includes a display driver, a head driver, and a motor driver. The display driver drives the display 4 of the operating block 11 in response to control signals delivered from the control block 200, i.e. in accordance with commands carried by the signals. Similarly, the head driver drives the print head 7 of the printer block 12 in accordance with commands from the control block 200. Further, the motor driver has a TF motor driver for driving the TF motor of the printer block 12, and a cutter motor driver for driving the cutter motor of the cutter block 13, and drives each motor in accordance with commands from the control block 200.

Next, according to the tape printing apparatus 1, the user can removably mount the external memory (hereinafter referred to as the “file pack storage”) 281 which is capable of storing data of a lot of document files and the like, as an auxiliary memory for use with a RAM 240, described hereinafter. The file pack storage 281 contains one or a plurality of (e.g. two) SRAMs (static RAMs), and is backed-up by batteries or the like, such that stored data can be preserved even when the file pack storage 281 is removed from the tape printing apparatus 1. Further, when the file pack storage 281 is mounted in a compartment of the external memory-mounting block 280, the file pack storage works such that it appears to the user to be part (e.g. one directory) of a memory area of the RAM 240, and is employed as a work area for carrying out control operations.

The operating block 11 includes the keyboard 3 and the display 4. The display 4 has a display screen 41 which is capable of displaying display image data e.g. of 198 by 64 dots on a rectangular display area of approximately 8 cm in the horizontal direction (X direction) by 4 cm in the vertical direction (Y direction). The display 4 is used by the user when he enters data via the keyboard 3 to form or edit matrix data representative of a character string image having characters, such as letters, numerals, symbols, simple figures, etc., (hereinafter generically referred to as “characters”) arranged therein or a print image including the character string image, view the resulting data, and enter various commands including option-selecting commands via the keyboard 3.

On the keyboard 3, there are arranged a character key group 31 including an alphabet key group, not shown, a symbol key group, not shown, a number key group, not shown, and a nonstandard character key group, not shown, for calling nonstandard characters for selection, as well as a function key group 32 for designating various operation modes. In a type of the apparatus 1 (Japanese language-adapted type) which is capable of entering the Japanese language, there is also provided a kana key group, not shown, for entering Japanese hiragana letters and Japanese katakana letters.

The function key group 32 includes a power key, not shown, a print key 322, for instructing a printing operation, a selection key 332, for finally determining entry of character data and starting new lines during text entry as well as determining selection of one of the various operating modes on a corresponding one of the selection screens, a color specification key, not shown, for specifying printing colors including neutral colors (mixed colors) of print image data, a color-setting key, not shown, for setting colors of characters and background colors, and four cursor keys 330 (330U (up arrow key), 330D (down arrow key), 330L (left arrow key), 330R (right arrow key)) for moving the cursor or the display range of display image data on the display screen 41 in respective upward, downward, leftward, and rightward directions.

The function key group 32 also includes a delete key 324 which is capable of deleting undetermined characters or a determined character, and at the same time instructing erasure of a whole sentence, a cancel key 326 for canceling instructions, a shift key, not shown, for use in changing roles of respective keys as well as modifying registered image data and nonstandard character registration image data, an image key, not shown, for alternately switching between a text entry screen or a selection screen and a display screen (image screen) for displaying print image data, a proportion-changing (zoom) key, not shown, for changing a proportion between the size of print image data and the size of display image data displayed on the image screen, a style key, not shown, for setting styles of labels to be formed, a file key 332, not shown, for handling files, an illustration key, not shown, for selecting background images, the aforementioned cut key, not shown, for manually cutting the tape T, a nonstandard character registration key, not shown, for registering nonstandard characters, a conversion key, not shown, for carrying out conversion operations, such as kana-kanji conversion (in the case of the Japanese language-adapted type of the apparatus), a pack key, not shown, for initialization of the file pack storage 281 or changing the settings thereof, a format key, not shown, for setting formats for printing background patterns or for fixed length printing, an enlarged-image print key, not shown, for instructing an enlarged-image printing operation for printing a print image which is formed by enlarging a basic image by a desired factor of enlargement, and the like.

Of course, similarly to keyboards of the general type, the above-mentioned key entries may be made by the respective keys exclusively provided therefor or by a smaller number of keys operated in combination with the shift key and/or the like. Here, for purposes of ease of understanding, the following description will be given assuming that there are provided as many keys as described above.

As shown in FIG. 1, from the keyboard 3, various commands and data described above are input to the control block 200. The control block 200 includes a CPU 210, a ROM 220, a character generator ROM (CG-ROM) 230, a RAM 240, and an input/output control circuit (IOC) 250, all of which are connected to each other by an internal bus 260.

The ROM 220 has a control program area 221 storing control programs executed by the CPU 210 as well as a control data area 222 storing control data including a color conversion table, a character modification table, and the like. The CG-ROM 230 stores font data, i.e. data defining characters, symbols, figures and the like, provided for the tape printing apparatus 1. When code data identifying a character or the like is input thereto, it outputs the corresponding font data. In the case of the Japanese language-adapted type, the control data area 222 also stores a kana-kanji conversion table for converting Japanese hiragana letters into corresponding Japanese kanji letters.

The RAM 240 is backed-up such that stored data items can be preserved even when the power is turned off by operating the power key. The RAM 240 includes areas of a register group 241 for storing values of flags, etc., a text data area 242 for storing text data of characters or the like entered by the user via the keyboard 3, a display image data area 243 for storing image data displayed on the display screen 41, a print image data area 244 for storing print image data, a registered image data area 245 for storing registered image data, a nonstandard character registration image data area 246 for storing nonstandard character registration image data, a background image data area 247 for storing background image data as candidates for background images and character color data corresponding thereto, and buffer areas 248 including a character image-forming buffer, a color conversion buffer, buffers for providing respective separate dithered image matrices of basic colors, a print buffer, and so forth. The RAM 240 is used as a work area for carrying out the control operations.

The IOC 250 incorporates a logic circuit for complementing the functions of the CPU 210 as well as dealing with interface signals for interfacing between the CPU 210 and peripheral circuits. The logic circuit is comprised of gate arrays, and custom LSI's. The IOC 250 also incorporates the function of a timer for measuring elapsed time. The IOC 250 is connected to the sensors of the sensor block 14 and the keyboard 3, for receiving the signals generated by the sensor block 14 as well as commands and data entered via the keyboard 3, and inputting these to the internal bus 260 directly or after processing them. Further, the IOC 250 cooperates with the CPU 210 to deliver data and control signals input to the internal bus 260 by the CPU 210 or the like, to the driving block 270 directly or after processing them.

Further, the IOC 250 is connected to the external memory-mounting block 280 to control the input and output of data apparently carried out by accessing the RAM 240 but actually carried out by accessing the file pack storage 281, whereby when the file pack storage 281 is mounted in the compartment of the external memory-mounting block 280, the IOC 250 carries out control operations such that the RAM 240 appears to be expanded (the memory capacity of the RAM 240 appears to be increased) to the user (in handling files and the like). Therefore, in the following, unless otherwise specified, description is given assuming that the RAM 240 includes a memory capacity of the file pack storage 281, and that data stored in the file pack storage 281 is stored in the RAM 240 (although shown as a file pack storage area 249 in FIG. 1 for purposes of clarity, part or all of each of the above areas can be actually shared with the file pack storage 281).

The CPU 210 of the control block 200 receives the signals and data from the components of the tape printing apparatus 1 via the IOC 250, according to the control program read from the ROM 220, processes font data from the CG-ROM 230 and various data stored in the RAM 240 (including the file pack storage area 249 (the file pack storage 281), as described above), and delivers signals and data to the components of the tape printing apparatus 1 via the IOC 250 to thereby carry out position control during printing operations, display control of the display screen 41, and print control that causes the print head 7 to carry out printing on the tape T under predetermined printing conditions. In short, the CPU 210 controls the overall operation of the tape printing apparatus 1.

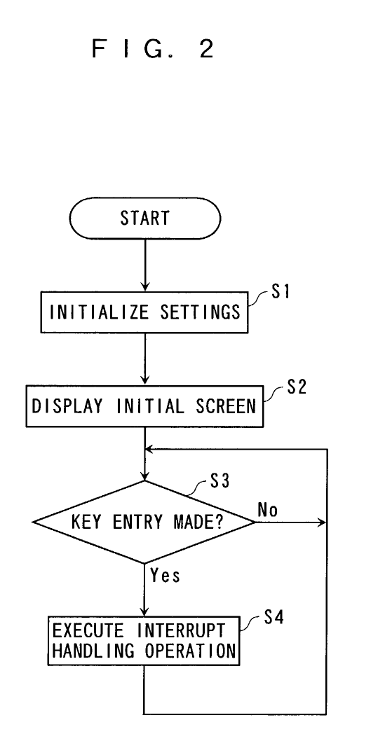

Next, the overall control process carried out by the tape printing apparatus 1 will be described with reference to FIG. 2. As shown in the figure, when the program for carrying out the control process is started e.g. when the power key is depressed (the power of the tape printing apparatus 1 is turned on), first, in a step S1, initialization of the system including restoration of saved control flags is carried out to restore the tape printing apparatus 1 to the state it was in before the power was turned off the last time. Then, the image that was displayed on the display screen 41 before the power was turned off the last time is shown as the initial screen in a step S2. The following steps in FIG. 2, that is, a step S3 for determining whether or not a key entry has been made and a step S4 for carrying out an interrupt handling operation are conceptual representation of actual operations. Actually, when the initial screen has been displayed in the step S2, the tape printing apparatus 1 enables an interrupt by key entry (keyboard interrupt), and maintains the key entry wait state (No to S3) until a keyboard interrupt is generated. When the keyboard interrupt is generated (Yes to S3), a corresponding interrupt handling routine is executed in the step S4, and after the interrupt handling routine is terminated, the key entry wait state is again enabled and maintained (No to S3).

As described above, in the tape printing apparatus 1, main processing operations by the apparatus are carried out by interrupt handling routines, and hence if print image data for printing is provided or has been prepared, the user can print the image data at a desired time, by depressing the print key 322 at the desired time and thereby generating a print interrupt to start a printing process, whereby the user can print a print image based on the print image data at the desired time. In short, the user can select any of possible operating procedures up to the printing operation as he desires.

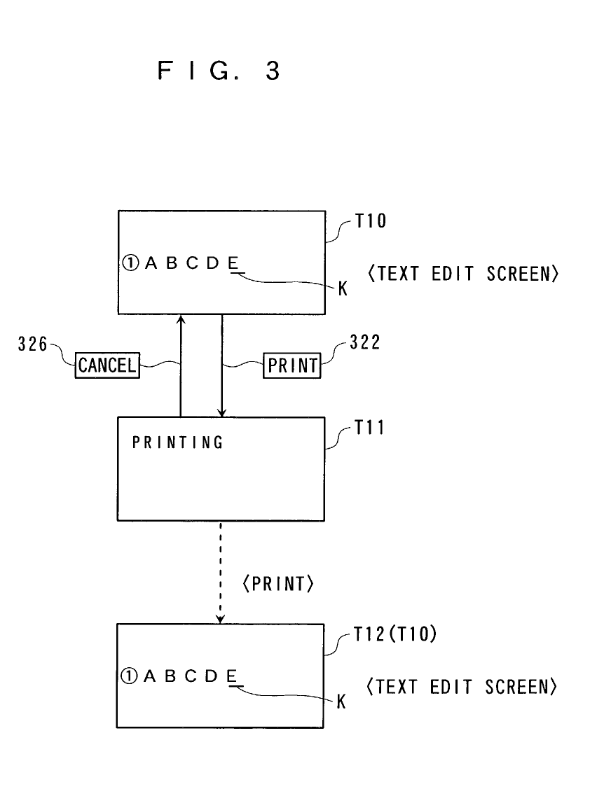

For instance, as shown in FIG. 3, if the print key 322 is depressed by the user when the text edit screen displays a letter (character) string “ABCDE” as a first line of the entry by the user [screen T10: hereinafter, contents displayed on the display screen 41 of the display 4 are referred to as the “screen T??” (? represents a digit) and the reference numerals for the screens are shown only by T??. Further, a cursor position is indicated in figures by a symbol K], a message “PRINTING” is displayed, and at the same time the character string image of the character string “ABCDE” is printed as a print image (T11). After the printing has been completed, the screen returns to the text edit screen (T12: the same as T10). The process of the above-mentioned kind is similar to the process carried out in the conventional tape printing apparatus, and hence detailed description thereof is omitted.

In a narrow sense, the terms “display image” and “print image” mean a displayed image itself and a printed image itself, respectively, and the apparatus 1 deals with display image data representative of a display image and print image data representative of a print image. That is, although in the apparatus 1, an object to be processed, i.e. formed, modified, or registered (recorded) is image data but not an image itself, for simplicity of the following description, “image data representative of˜image” is referred to as “˜image”, similarly to the image itself.

Now, in the tape printing apparatus 1, a label producing method is employed which is capable of easily producing an index tab label which has front and rear faces thereof printed with indexes partially different from each other. In the following, the label producing method will be described in detail.

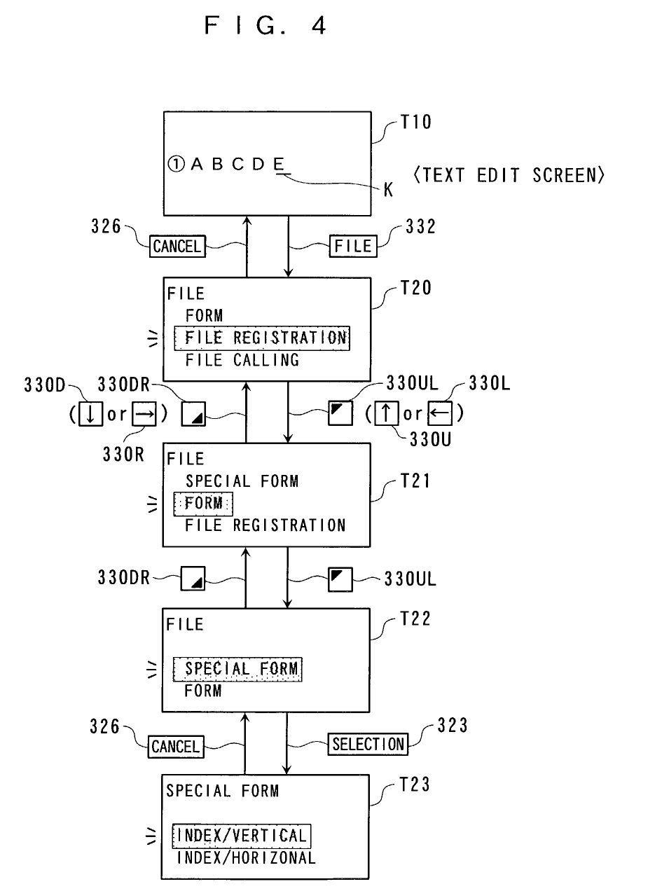

First, as shown in FIG. 4, when the file key 332 is depressed (operated) by the user in the state (T10) of the text edit screen being displayed, as described above with reference to FIG. 3, a selection screen at the first hierarchical level for “FILE” for selecting and setting one of various forms is displayed (T20). It should be noted that in the tape printing apparatus 1, the user can cancel instructions provided via the keyboard 3 by operating the cancel key 326. That is, the selection screen can be returned to the original text edit screen (T10) by depressing the cancel key 326 in the state of the screen at the first hierarchical level (T20) being displayed (the cancel key 326 similarly acts in all cases unless otherwise specified, and hence description of this operation in each state of the screen will be omitted hereinafter).

On the selection screen (T20), menu options, such as “FORM”, “FILE REGISTRATION”, “FILE CALLING”, “FILE DELETE”, . . . “END?”, and the like are displayed as menu options of “FILE”. The user can display any one of the menu options in reverse video or in the flashing state (in the illustrated examples, expressed by shading of character images with dots) by operating the cursor key 330, and select and designate the menu option displayed in reverse video or in the flashing state by depressing the selection key 323. Immediately after the screen is switched to each selection screen, an option selected (accessed) the last time (or an option selected by default according to the result of initialization of the system, if there is no option selected the last time) is displayed in reverse video. Further, when the user displays another option by operating the cursor key 330, the option is displayed in the flashing state since it is not the option selected the last time.

It should be noted that an option displayed in reverse video or in the flashing state on a selection screen in the tape printing apparatus 1 is one to be selected by subsequent user's operation of the selection key 323, and hence the option in one of these states is referred to as an “option highlighted for selection”. Further, in the following description, it is assumed that all the options selected are displayed in the flashing state (in the illustrated examples, expressed by shading of character images with dots) irrespective of whether or not they are the options selected the last time. Further, in the following, for efficiency of description, the down arrow key 330D and the right arrow key 330R are collectively referred to as the “cursor key 330DR” which is represented in FIG. 4 as a box containing a black triangle pointing in a downward and rightward direction. Similarly, the up arrow key 330U and the left arrow key 330L are collectively referred to as the “cursor key 330UL” which is represented in the figure as a box containing a black triangle pointing in a upward and leftward direction.

For instance, when the down arrow key 330D or the right arrow key 330R (cursor key 330DR) is depressed by the user from the above state (T20), the menu option “FILE CALLING” is highlighted for selection. Thereafter, whenever the cursor key 330DR is operated, the menu options, such as “FILE DELETE”, . . . “END?”, are displayed. Inversely, when the up arrow key 330U or the left arrow key 330L (cursor key 330UL) is depressed, the menu options “FORM and “SPECIAL FORM” are highlighted for selection in accordance with operation of the cursor key 330UL (T20 to T22).

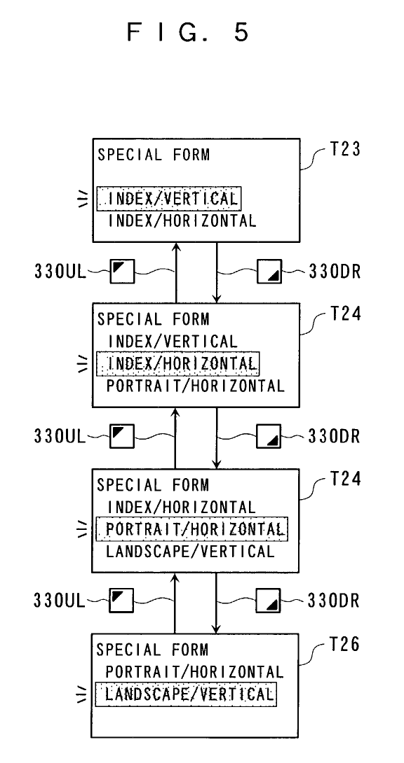

In this example, in order to set the form “SPECIAL FORM”, it is assumed that the selection key 323 is depressed (operated) in the state of the option “SPECIAL FORM” being highlighted for selection (T22). In this case, when the selection key 323 is depressed by the user, the “SPECIAL FORM” is selected to switch to a selection screen at the second hierarchical level under the option of the “SPECIAL FORM” (T23: commonly shown in FIG. 5).

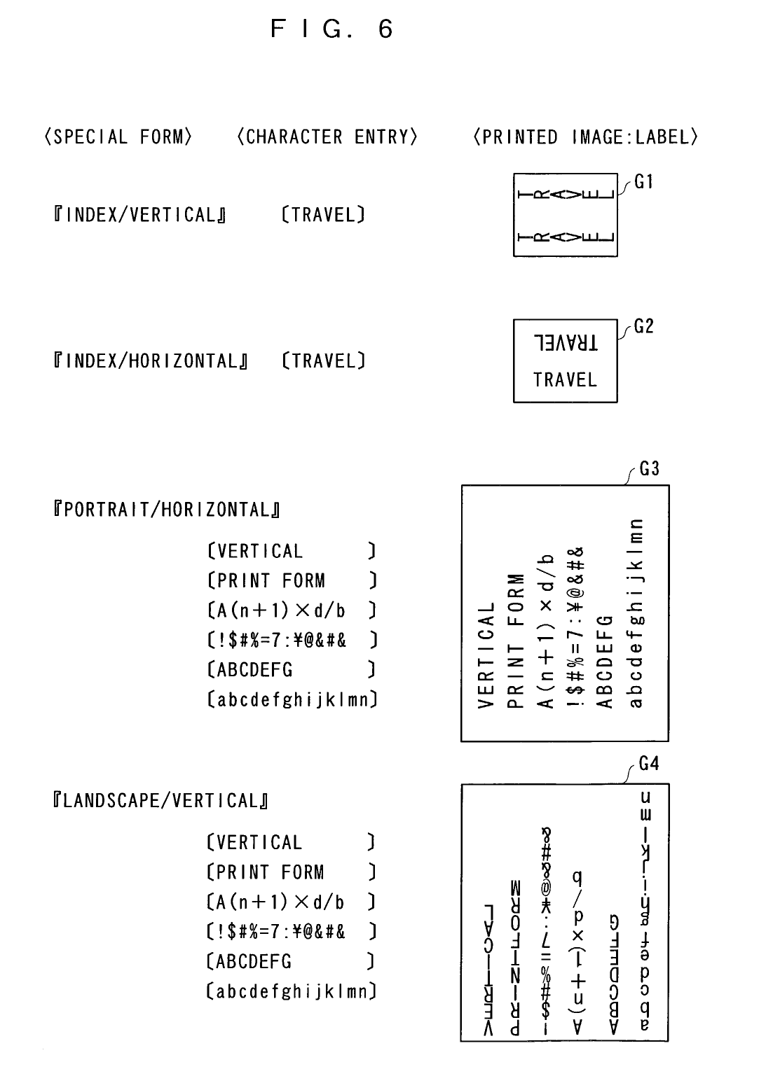

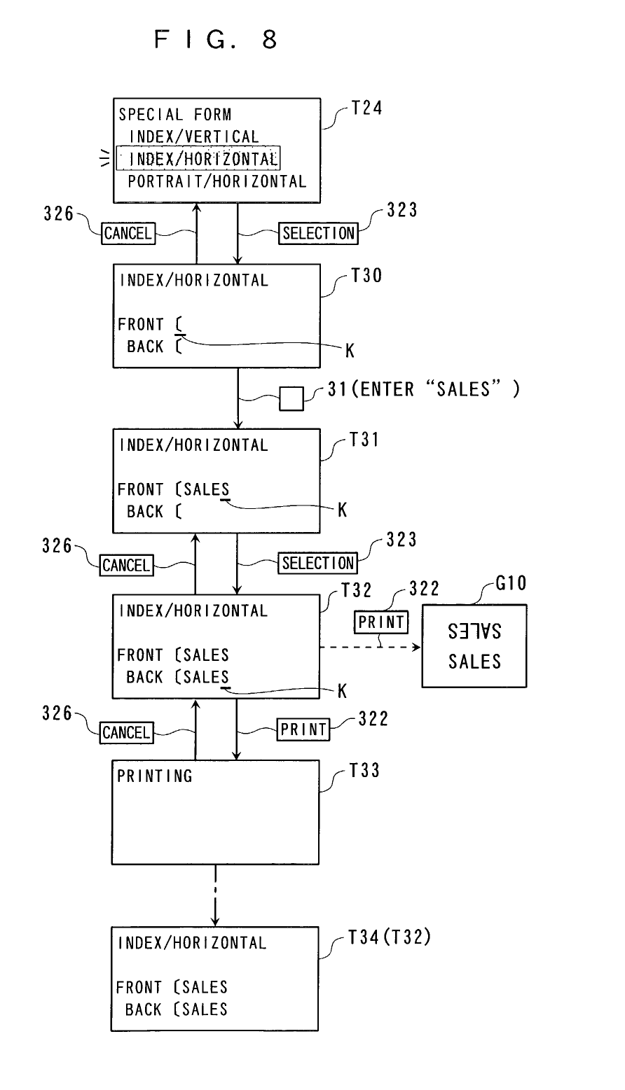

Referring to FIGS. 5 and 6, on the selection screen at the second hierarchical level under the option of the “SPECIAL FORM”, menu options, such as “INDEX/VERTICAL” (index/vertical writing), “INDEX/HORIZONTAL” (index/horizontal writing), “PORTRAIT/HORIZONTAL” (portrait form/horizontal writing”, so forth “LANDSCAPE/VERTICAL” (landscape form/vertical writing) so forth are displayed as menu options of the “SPECIAL FORM” (T23 to T26: T24 is commonly shown in FIG. 8). Hence, the user can select and designate any one of the above menu options by operating the cursor key 330 to highlight the menu option for selection, and depresses the selection key 323.

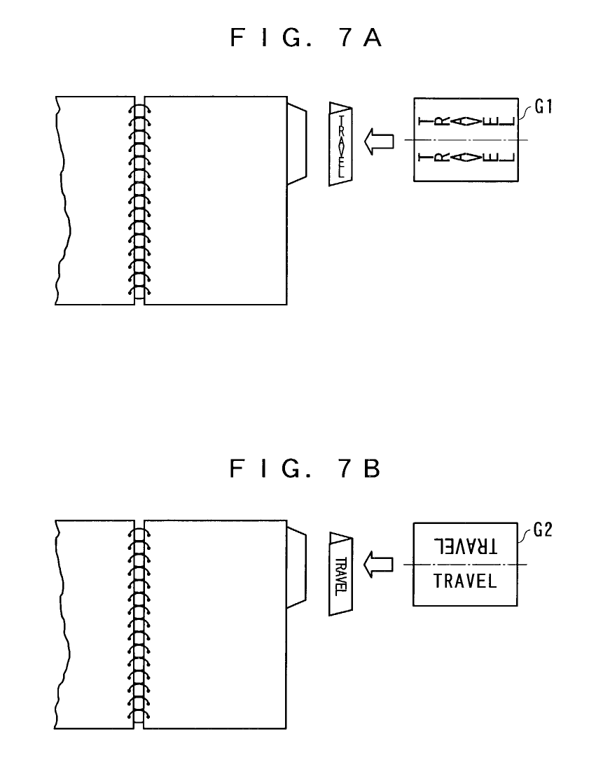

As shown in FIGS. 7A and 7B, of the above menu options, the options “INDEX/VERTICAL”and “INDEX/HORIZONTAL” each indicate a “special print form” for producing a label (index tab label) which can be formed into an index tab (having front and rear faces thereof printed with indexes). In this special print form, indexes to be arranged on the front and rear faces of an index tab are printed side by side on the label such that the label is formed into an index tab when it is folded along an imaginary center line (a one-dot-chain line as shown in the figure) for affixation to an object article. In short, here, to produce an index tab label G1 or G2, the option “INDEX/VERTICAL” or “INDEX/HORIZONTAL” is selected.

It should be noted that since the description is given of horizontal writing, and characters (letters) are entered mainly in horizontal writing as shown in the figures (see FIG. 8, for instance), the following description will be given assuming that the “INDEX/HORIZONTAL” is selected for purposes of convenience of comparison in description. Of course, it is possible to apply the following description to the “INDEX/VERTICAL”.

Referring to FIG. 8, when the selection key 323 is depressed by the user in the state of the “INDEX/HORIZONTAL” of the menu options of the “SPECIAL FORM” being highlighted for selection (T24: commonly shown in FIG. 5), the “INDEX/HORIZONTAL” is selected, and a text edit screen (at the third hierarchical level) under the “INDEX/HORIZONTAL”, that is, an edit screen permitting the user to enter and edit character strings (letter strings) to form an index is displayed (T30).

As shown in the figure, on this edit screen, first, a bracket “[” indicative of a letter entry start position, placed immediately after a letter string “FRONT” is indicated by the cursor K. Now, let it be assumed that one of the opposite surfaces of an index tab label is referred to as a front surface, and a letter string to be used as an index on the front surface side is referred to as a “front side character string” (front side letter string). Then, from the above state (T30), a front side letter string can be entered and edited. For instance, as shown in the figure, the user can enter a letter string “SALES” by operating the character key group 31 (T31).

At a time point of termination of the entry and edit of the front side letter string, the user can finally determine the entry of the front side letter string by depressing the selection key 323 (also serving as a new line start key, as described above) (T32). At this time, in the present embodiment, in forming a document comprised of two lines with the front side letter string being set to the first line, the starting of a new line is instructed, whereby the entry of the first line is finally determined, and at the same time the letter string (front side letter string) on the first line is automatically copied as a draft of a letter string to be printed on the next line (second line), that is, on the rear face of an index tab label (T32). Although in the present embodiment, the front side letter string is newly and automatically copied after depression of the selection key (for a new line start instruction), this is not limitative, but, for instance, in parallel with the entry of the front side letter string (in a text buffer for the first line), the same letter string may be stored in a text buffer for the second line on the rear face side (by automatically copying the same) to merely “display” the second line provided in the buffer simultaneously with the final determination of the first line.

Since the front side letter string is copied to form a draft of a rear side letter string, the user can operate the print key 322 from the above state (T32) for printing, to thereby produce an index tab label G10 having the same letter string “SALES” printed on the front and rear faces thereof. More specifically, when the print key 322 is depressed by the user, the same message “PRINTING” as shown in FIG. 3 is displayed, and the front side letter string “SALES” and the rear side letter string “SALES” are printed on the tape T side by side on opposite sides of an imaginary center line such that the index tab label G10 can be produced (T33). Then, upon completion of the printing operation, the display screen returns to the original text edit screen (T34: the same as T32).

It should be noted that since an operating procedure for executing a printing process and a sequence of screens (T32 to T34) displayed during the printing process are similar to those illustrated in FIG. 3, in the following, the screens and detailed descriptions of the operating procedure for printing are omitted, and only the print key 322 and a label as a result of printing are displayed as shown in a right side portion of FIG. 8.

As described hereinabove, according to the index tab label-producing method employed in the tape printing apparatus 1 of the present embodiment, the front side letter string (front side character string) and the rear side letter string (rear side character string) are handled as respective lines of a document comprised of two lines of letter strings in total. The entry of the front side letter string is finally determined after all the letters forming the front side letter string have been entered, by depressing the selection key 323 (for a new line start instruction), and at the same time the front side letter string is automatically copied such that the front side letter string can be used as a draft copy for the rear side letter string (T31→T32).

As a result, similarly to a case where transition from entry and edit of a first line to entry and edit of a second line is carried out during editing of a general document comprised of two lines, transition from entry and edit of a front side letter string (first line) to edit of a rear side letter string (second line) can be performed easily in response to a new line start instruction, which facilitates editing operations. Further, since the front side and rear side letter strings are displayed as the respective lines of a document, it is possible to easily enter and edit the letter strings with reference to the results of the display. Further, when a rear side letter string is formed, a front side letter string is automatically copied first in response to depression of the selection key 323 (new line start instruction) as a trigger. This makes it possible to save the trouble of entering the rear side letter string (T31→T32). Furthermore, since the forming of the rear side letter string is triggered by the new line start instruction, it is possible to clearly restrict (control) timing in which transition from the entry and edit of the front side letter string to the edit of the rear side letter string is carried out. This facilitates the operating procedures and editing operations.

Although in the example illustrated in FIG. 8, the same letter string “SALES” is used as indexes on the front and rear faces of the index tab label, it is possible to use letter strings different from each other as indexes on the front and rear faces, since the letter strings can be basically dealt with as two different lines of the same document. This capability is convenient for dealing with letter strings having only parts thereof different from each other.

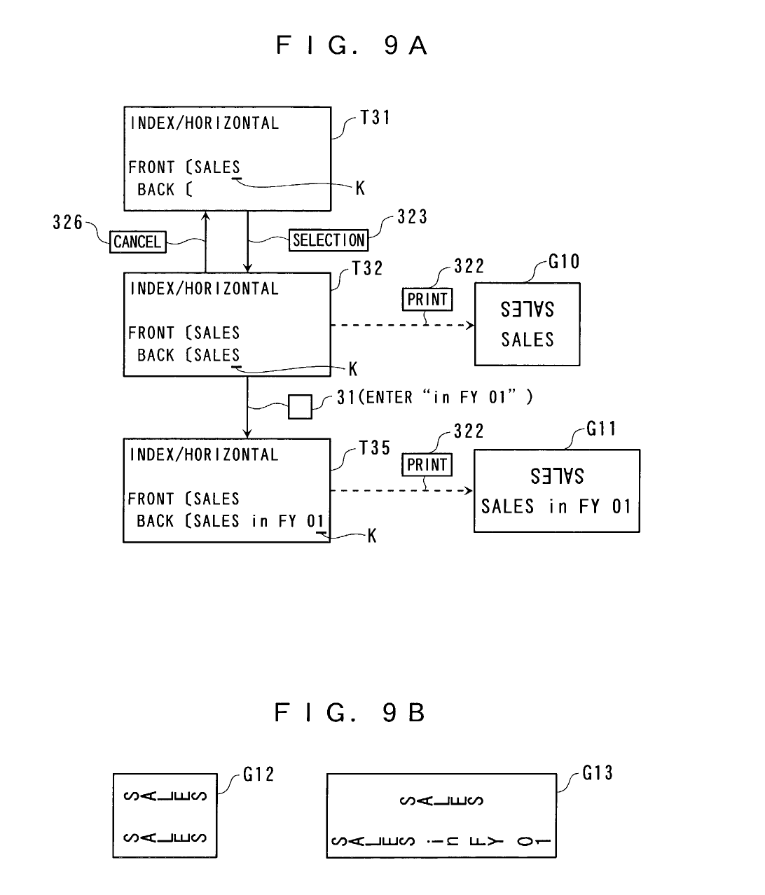

If the print key 322 is depressed (for a new line start instruction) after the entry and edit of a front side letter string (first line) (T31: commonly shown in FIG. 8) have been terminated, and the entry of the front side letter string is finally determined by depressing the selection key 323 (for a new line start instruction) thereby automatically copying the front side letter string, it is possible to produce the index tab label G10, described above with reference to FIG. 8, having the same index printed on the front and rear faces thereof. However, for instance, from this state (T32), if the editing process is carried out furthermore to add a letter string “in FS 01” (in fiscal year 01) (T35), as shown in FIGS. 9A and 9B, and then printing is instructed, an index tab label G11 having the letter string “SALES” printed on a front surface thereof and a letter string “SALES in FY 01” (sales in fiscal year 01) printed on a rear face thereof can be produced.

As described hereinabove, in the tape printing apparatus 1, indexes to be printed on the front and rear faces of an index tab can be printed side by side on a label such that the label forms an index tab when it is folded along an imaginary center line for affixation to an object article. To this end, first, a front side letter string (front side character string) is entered and edited. Then, the front side letter string is copied and edited as a draft of a rear side letter string (rear side character string), and the front side letter string and the rear side letter string edited are printed side by side on a tape (print medium). Thus, the index tab label G11 can be produced.

In the above case, the front side letter string is copied and edited as a draft of the rear side letter string, so that when only part of an index on the back side is different from an index on the front side, there is no need to enter the whole rear side letter string, and only the different part is required to be edited. This makes it possible to save the trouble of entering the rear side letter string. Moreover, since the front and rear faces of a label do not have to have a completely identical index, an index tab label can be easily produced which has front and rear faces thereof printed with indexes partially different from each other. Further, it goes without saying that as described above, the option “INDEX/VERTICAL” can be selected to employ the special print form similarly to the case of the “INDEX/HORIZONTAL” being selected (see the FIG. 9B index tab labels G12, G13 in vertical writing).

Although in the above example, after termination of the entry and edit of the front side letter string (first line) (T31), the entry of the front side letter string is finally determined by depressing the selection key 323 (for a new line start instruction), and the front side letter string is automatically copied, this is not limitative, but it may be confirmed whether or not the front side letter string is copied before the copy is executed.

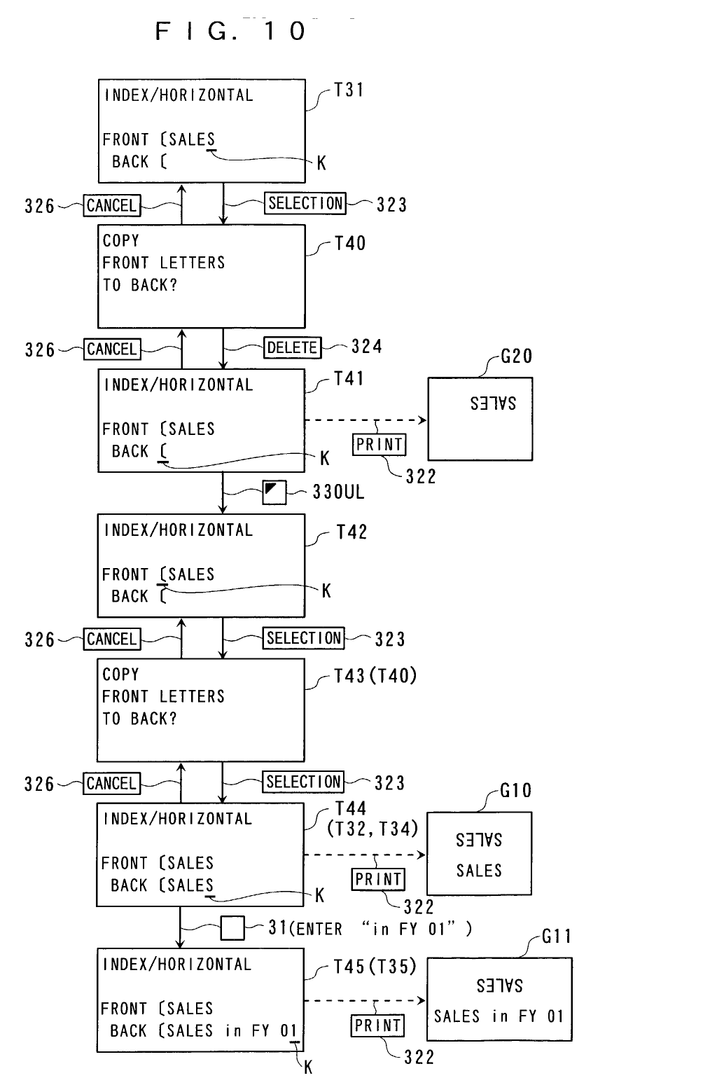

For instance, as shown in FIG. 10, after the entry and edit of the front side letter string (first line) have been terminated (T31: commonly shown in FIGS. 8 and 9A), and the entry of the front side letter string is finally determined by depressing the selection key 323 (for a new line start instruction), it is confirmed whether or not the front side letter string should be copied to form a draft of the rear side letter string (T40). More specifically, a confirmation message “COPY FRONT LETTERS TO BACK?” is displayed (T40).

In the above state (T40), if the delete key 324 is depressed by the user (when copying is denied, i.e. when “denial of copying” is instructed), the front side letter string is not copied, and a wait state for waiting for entry of a rear side letter string is enabled and maintained (T41). Therefore, when the print key 322 is depressed (to instruct printing) in this state (T41), it is possible to produce an index tab label G20 printed with only the front side letter string “SALES”.

It should be noted that from the above state (T41), the display screen can be returned to the state (T42) of the front side letter string (first line) being edited, by operating the cursor K, that is, in a manner moving the cursor K from a second line to a first line, of a normal document comprised of two lines. This state (T42), which is distinguished from the first state (T31) illustrated in FIG. 10 only in cursor position, is a state of the front side letter string being edited, similar to the first state (T31). From this state (T42), when the selection key 323 is depressed (for a new line start instruction) by the user, the entry of the front side letter string is finally determined, and at the same time it is confirmed whether or not the front side letter string is copied to form a draft of the rear side letter string (T43: the same as T40).

Then, in the above state (T43), when the selection key 323 is depressed (when “confirmation of copying” is instructed) by the user, the front side letter string is copied to form a draft of the rear side letter string (T44: the same as T32, T34 in FIG. 8, and T32 in FIG. 9A). Therefore, when the print key 322 is depressed (to instruct printing) in this state (T44), it is possible to produce the index tab label G10 having the same letter string “SALES” printed on the front and rear faces thereof. Further, if this editing process is carried out furthermore from this state to add the letter string “in FY 01” (T45: the same as T35 in FIG. 9A), and then printing is instructed, it is possible to produce the index tab label G11 having the letter string “SALES” printed on the front surface thereof and the letter string “SALES in FY 01” printed on the rear face thereof.

According to the label producing method in the above example, it is confirmed whether copying of the front side letter string (front side character string) should be executed or inhibited, and when it is confirmed that copying of the front side letter string is to be executed, the front side letter string is copied. Therefore, if execution of copying the front side letter string is denied, it is possible to stop the execution of copying, which facilitates employment of amethod other than the method of simply copying the front side letter string, thereby increasing the freedom of editing. More specifically, since the editing process goes through the step of confirming whether the copying is to be executed or inhibited, it is possible not only to copy the front side letter string unconditionally but also to carry out processing permitted only before execution of the copying operation or select inhibition of the copying operation, with increased freedom. This makes it possible to edit letter strings more easily.

It should be noted that copied text of the front side letter string maybe left undetermined instead of questioning as to the “confirmation of copying” as in the above example, whereby it is possible to carry out the operation (processing) to the same effect.

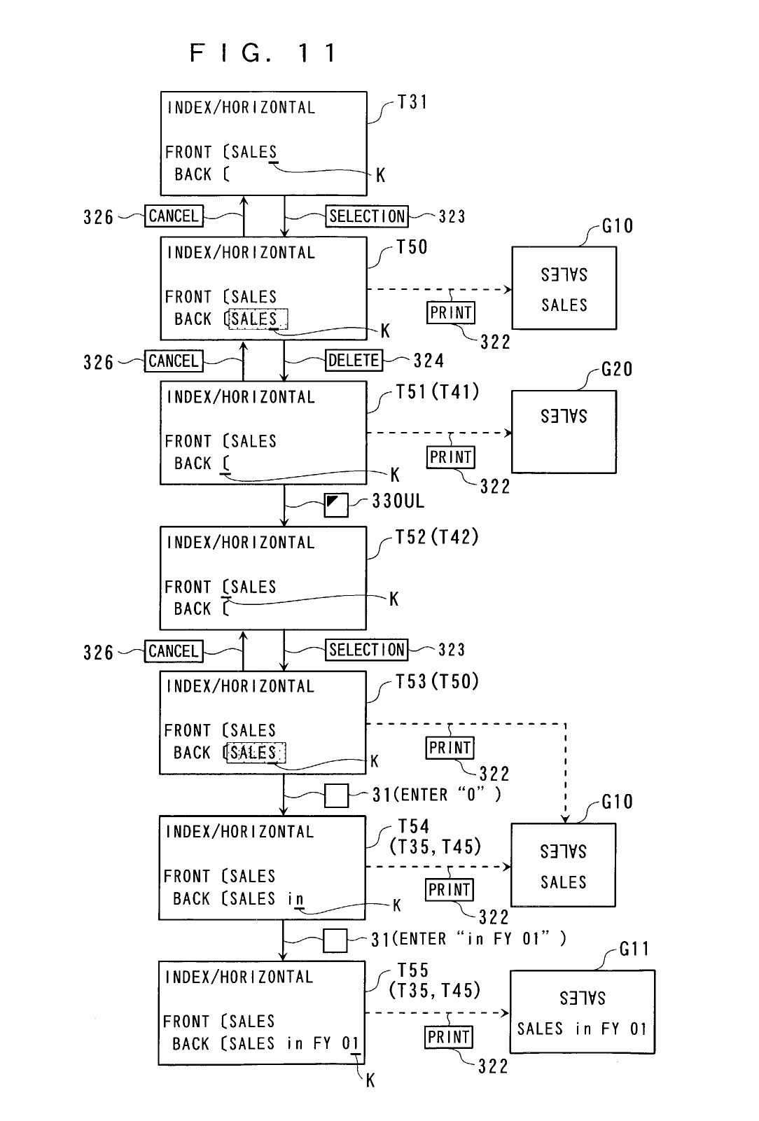

For instance, as shown in FIG. 11, after the entry and edit of the front side letter string (first line) have been terminated (T31: commonly shown in FIGS. 8 to 10), and the entry of the front side letter string is finally determined by depressing the selection key 323 (for a new line start instruction), the front side letter string is copied to form a draft of the rear side letter string. In the example illustrated in FIG. 11, the copied front side letter string is dealt with as a provisionally determined draft (in the illustrated example, expressed by shading of character images with dots) (T50). In this state (T50), when the delete key 324 is depressed by the user (when “deletion” of the provisionally determined portion is instructed), the provisionally determined portion (provisionally determined draft of the rear side letter string) is deleted, and a wait state for waiting for entry of a rear side letter string is enabled and maintained (T51: the same state as T41 in FIG. 10). Therefore, if the print key 322 is depressed (to instruct printing) in this state (T51), it is possible to produce the index tab label G20 printed with only the front side letter string “SALES”.

Further, the same operating procedure as illustrated in FIG. 10 (T41 to T42), the display screen is returned to the state of the front side letter string being edited (T51 to T52) similar to the first state (T31). Then, if the selection key 323 is depressed (for a new line start instruction) by the user, the entry of the front side letter string is finally determined, and the front side letter string is copied to form a provisionally determined draft of the rear side letter string (T53: the same as T50). In this state (T53), when the selection key 323 is depressed by the user (when “determination” is instructed), the provisionally determined draft is made a determined draft (T54: the same as T44 in FIG. 10).

Therefore, if the print key 322 is depressed (to instruct printing) in this state (T54), it is possible to produce the index tab label G10 having the same letter string “SALES” printed on the front and rear faces thereof. Further, if this editing process is carried out furthermore to add the letter string “in FY 01” (T55: the same as T35 in FIG. 9A and T45 in FIG. 10), and then printing is instructed, it is possible to produce the index tab label G11 having the letter string “SALES” printed on the front surface thereof and the letter string “SALES in FY 01” printed on the rear face thereof.

According to the label producing method in the above example, the front side letter string (front side character string) automatically copied is dealt with as a provisionally determined draft of the rear side letter string (rear side character string), and entry thereof is finally determined during editing. Therefore, the draft of the rear side letter string can be deleted in response to the instruction for deleting the provisionally determined draft, which facilitates employment of a method other than the method of simply copying the front side letter string, thereby increasing the freedom of editing. More specifically, copied text of the front side letter string is once placed in a provisionally determined state, so that when the rear side letter string is edited, it is possible not only to perform processing enabled only for text in the provisionally determined state but also to select inhibition of the copying operation, with increased freedom. This further facilitates editing.

Further, in the above example, the instruction for deleting the provisionally determined draft is provided by depression of the delete key 324, which is an operation for instructing deletion of one letter from the determined draft. That is, the instruction is issued by the same key operation as carried out in providing an instruction for deleting one letter from the determined draft, and hence the same operation produces different results depending on whether or not the rear side letter string is provisionally determined. Inversely, it is possible to instruct different processes responsive to circumstances by the same operation, thereby increasing the variation of operability of the apparatus in editing.

Although in each of the above examples, similarly to the case where transition from entry and edit of a first line to edit of a second line is carried out during editing of a general document comprised of two lines, the automatic copying of the front side letter string (the examples illustrated in FIGS. 8 and 9A, and FIG. 11), and confirmation of whether or not copying of the front side letter string is (intended) to be executed (the example illustrated in FIG. 10) are triggered by depressing the selection key 323 (for a new line start instruction), this is not limitative, but it is possible to implement separate means for carrying out an operating method for issuing a new line start instruction to start a new line while executing automatic copying at the same time, and an operating method for issuing a new line start instruction to start a new line without executing automatic copying, respectively.

For instance, the depression of the selection key 323 may be associated with issuing “the new line start instruction without automatic copying”, while a predetermined special key for copying, hereinafter referred to as “the copy key 340”, may be provided besides the selection key 323 (by performing key assignment), whereby depression of this key may be associated with issuing “the new line start instruction with automatic copying”.

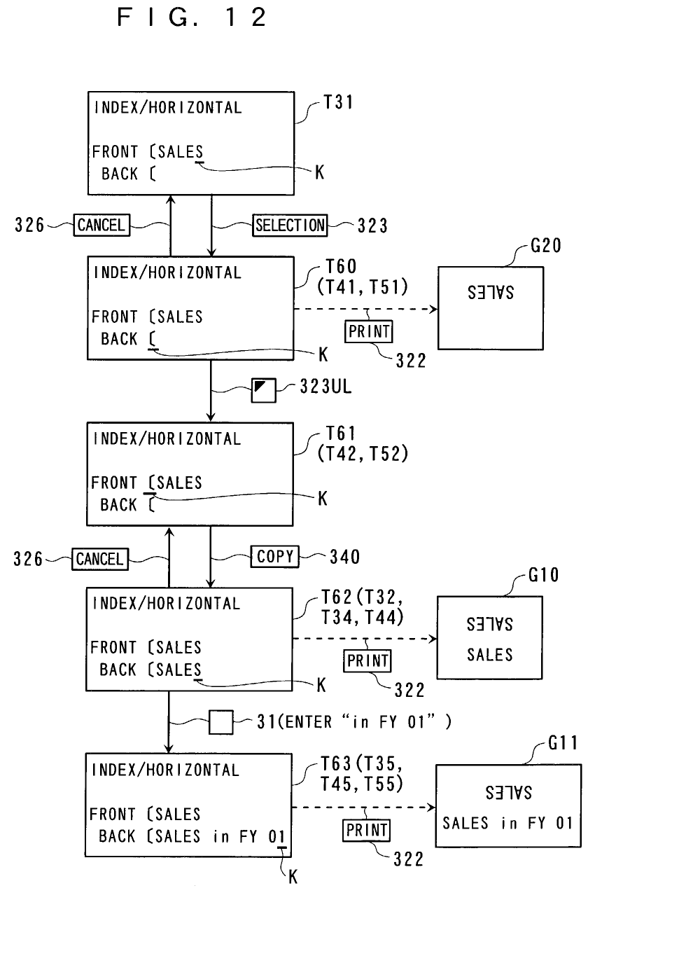

In the above case, as shown in FIG. 12, after termination of the entry and edit of the front side letter string (first line) (T31: commonly shown in FIGS. 8 to 11), the entry of the front side letter string is finally determined by the user's depression of the selection key 323 (for the new line start instruction without automatic copying), and at the same time a wait state for waiting for entry of a rear side letter string is enabled and maintained (without carrying out automatic copying) (T60: the same state as T41 in FIG. 10, and T51 in FIG. 11). Therefore, when the print key 322 is depressed (to instruct printing) in this state (T60), it is possible to produce the index tab label G20 printed with only the front side letter string “SALES”.

Further, from a similar state (T61: the same state as T42 in FIG. 10, and T52 in FIG. 11), when the copy key 340 is depressed by the user (for the new line start instruction with automatic copying), the entry of the front side letter string is finally determined, and at the same time the front side letter string is automatically copied (T62: the same as T32, etc.). When the print key 322 is depressed (to instruct printing) in this state (T62), it is possible to produce the index tab label G10 having the same letter string “SALES” printed on the front and rear faces thereof. Further, if this editing process is carried out furthermore to add the letter string “in FY 01” (T63: the same as T35, etc.), and then printing is instructed, it is possible to produce the index tab label G11 having the letter string “SALES” printed on the front surface thereof and the letter string “SALES FS 01” printed on the rear face thereof.

In the label producing method in the above example, it is possible to issue “the new line start instruction without automatic copying” and “the new line start instruction with automatic copying”. When execution of automatic copying is instructed, the front side letter string (front side character string) is copied. Further, by forming a draft of the rear side letter string (rear side character string as a blank) without copying the front side letter string, the rear side letter string can be formed (edited) by editing the blank as the draft (i.e. by carrying out a new entry). This facilitates employment of a method other than the method of simply copying the front side letter string, thereby enhancing the freedom of editing.

More specifically, it is possible to instruct whether (automatic) copying is to be permitted (or executed) or not. Since the copying is carried out only going through this instruction step, it is possible not only to copy the front side letter string unconditionally but also to execute processing enabled only before copying or select inhibition of the copying, with increased freedom. This further facilitates editing.

Although in the above embodiment, the tape printing apparatus of a thermal type is employed by way of example, this is not limitative, but the present invention can be similarly applied to a different type tape printing apparatus so long as it can produce index tab labels. Further, as a print medium, it is possible to select not only a tape but also a desired print medium so long as it can form an index tab e.g. by cutting off a printed portion thereof and/or removing a peel-off paper therefrom. Hence, the present invention is applicable not only to a tape printing apparatus but also to a desired printing apparatus capable of printing on a print medium other than a tape.

It is further understood by those skilled in the art that the foregoing is a preferred embodiment of the invention, and that various changes and modifications may be made without departing from the spirit and scope thereof.

What is claimed is:

1. A label producing method for producing an index tab label which has character strings printed on opposite sides of an imaginary center line thereof, and is capable of forming an index tab by being folded along the imaginary center line and affixed such that the index tab has the character strings printed on a front face and a rear face thereof as a front index and a rear index,
the label producing method comprising the steps of:
entering and editing a front side character string for forming the front index printed on the front face of the index tab;
producing a draft of a rear side character string for forming the rear index printed on the rear face of the index tab by copying the front side character string;
editing the rear side character string formed as the draft of the rear side character string; and
printing the front side character string and the edited rear side character string side by side on a print medium such that the index tab label can be produced.

2. A label producing method according to claim 1, wherein the front side character string and the rear side character string are handled as respective lines of a document formed by two lines of character strings in total, and
wherein entry of the front side character string is finally determined in response to a new line start instruction after all the characters forming the front side character string have been entered.

3. A label producing method according to claim 2, further including the step of displaying a line printed with the front side character string and a line printed with the rear side character string as the respective lines of the document.

4. A label producing method according to claim 2, wherein the step of producing a draft of the rear side character string includes starting a process for producing the draft by using the new line start instruction as a trigger.

5. A label producing method according to claim 1, wherein the step of producing a draft of the rear side character string includes the step of automatically copying the front side character string to produce the draft.

6. A label producing method according to claim 5, wherein the front side character string automatically copied is dealt with as a provisionally determined draft of the rear side character string, and
wherein the step of editing the rear side character string includes the step of finally determining the provisionally determined draft of the rear side character string.

7. A label producing method according to claim 6, wherein the step of editing the rear side character string includes the step of being capable of deleting the draft of the rear side letter string in response to an instruction for deleting the provisionally determined draft.

8. A label producing method according to claim 7, wherein the instruction for deleting the provisionally determined draft is issued by the same operation as carried out in issuing an instruction for deleting one letter from a determined draft.

9. A label producing method according to claim 1, wherein the step of producing a draft of the rear side character string includes the steps of confirming whether copying of the front side character string should be executed or inhibited, and executing the copying of the front side character string when it is confirmed that the copying of the front side character string should be executed.

10. A label producing method according to claim 9, wherein the step of producing a draft of the rear side character string further includes the step of being capable of stopping execution of the copying of the front side character string in response to denial of the execution of the copying.

11. A label producing method according to claim 1, wherein the step of producing a draft of the rear side character string includes the steps of being capable of instructing execution of the copying of the front side character string, and carrying out the copying of the front side character string when the execution of the copying is instructed.

12. A label producing method according to claim 11, wherein the step of producing a draft of the rear side character string includes the step of setting a blank to the draft of the rear side character string in place of executing the copying of the rear side character string.

13. A label producing apparatus for producing an index tab label which has character strings printed on opposite sides of an imaginary center line thereof, and is capable of forming an index tab by being folded along the imaginary center line and affixed such that the index tab has the character strings printed on a front face and a rear face thereof as a front index and a rear index,
the label producing apparatus comprising:
front side character string entry means for entering and editing a front side character string for forming the front index printed on the front face of the index tab;
rear side character string draft-producing means for producing a draft of a rear side character string for forming the rear index printed on the rear face of the index tab by copying the front side character string;
rear side character string-editing means for editing the rear side character string formed as the draft of the rear side character string; and
printing means for printing the front side character string and the edited rear side character string side by side on a print medium such that the index tab label can be produced.

14. A label producing apparatus according to claim 13, wherein the front side character string and the rear side character string are handled as respective lines of a document formed by two lines of character strings in total, and
wherein entry of the front side character string is finally determined in response to a new line start instruction after all the characters forming the front side character string have been entered.

15. A label producing apparatus according to claim 14, further including display means for displaying a line printed with the front side character string and a line printed with the rear side character string as the respective lines of the document.

16. A label producing apparatus according to claim 14, wherein said rear side character string draft-producing means starts a process for producing the draft by using the new line start instruction as a trigger.

17. A label producing apparatus according to claim 13, wherein said rear side character string draft-producing means includes automatic copying means for automatically copying the front side character string to produce the draft.

18. A label producing apparatus according to claim 17, wherein the front side character string automatically copied is dealt with as a provisionally determined draft of the rear side character string, and
wherein said rear side character string-editing means includes rear side character string draft-determining means for finally determining the provisionally determined draft of the rear side character string.

19. A label producing apparatus according to claim 18, wherein said rear side character string-editing means includes provisionally determined rear side character string-deleting means capable of deleting the draft of the rear side letter string in response to an instruction for deleting the provisionally determined draft.

20. A label producing apparatus according to claim 19, wherein the instruction for deleting the provisionally determined draft is issued by the same operation as carried out in issuing an instruction for deleting one letter from a determined draft.

21. A label producing apparatus according to claim 13, wherein said rear side character string draft-producing means includes copy execution-confirming means for confirming whether copying of the front side character string should be executed or inhibited, and copy execution means for executing the copying of the front side character string when it is confirmed that the copying of the front side character string should be executed.

22. A label producing apparatus according to claim 21, wherein said rear side character string draft-producing means further includes copy execution-stopping means capable of stopping execution of the copying of the front side character string in response to denial of the execution of the copying.

23. A label producing apparatus according to claim 13, wherein said rear side character string draft-producing means includes copy execution-instructing means capable of instructing execution of the copying of the front side character string, and copy execution means for executing the copying of the front side character string when the execution of the copying is instructed.

24. A label producing apparatus according to claim 23, wherein said rear side character string draft-producing means includes blank draft-producing means for employing a blank as the draft of the rear side character string in place of executing the copying of the rear side character string.
